(19) United States
(12) Patent Application Publication
(10) Pub. No.: US 2007/0204026 A1
(43) Pub. Date: Aug. 30, 2007

(54) Method For Blocking Unwanted E-Mail Based On Proximity Detection

(75) Inventor: Robert Berger, New York, NY (US)

Correspondence Address: KATTEN MUCHIN ROSENMAN LLP, 575 MADISON AVENUE, NEW YORK, NY, 10022-2585, US

(73) Assignee: U.S. TELECOM INC., New York, NY (US)

(21) Appl. No.: 11/632,258

(22) PCT Filed: Jul. 27, 2005
(86) PCT No.: PCT/US05/26527

§ 371 Date: Jan. 11, 2007

Related U.S. Application Data
(60) Provisional application No. 60/591,349, filed on Jul. 27, 2004.

(51) Int. Cl. G06F 15/173

(52) U.S. Cl. 709/223

(57) ABSTRACT

The abstract must be less than 150 words, or 200 words when no figure is to be published. Proximity detection algorithms are used to determine whether or not the render of the message is authentic, by verifying if the sending host (242) is within proximity of registered MX Hosts 182, WWW Hosts, and/or DNS servers forth alleged sending domain. Proximity detection, combined with Select Reverse DNS lookups (153), provides extremely effective and accurate e-mail source verification system (110,107). As this combination relies solely on the existing Internet Domain Name System for its identifying matrix, an affective anti-SPAM system/method is realized without making any changes to any installed e-mail systems. In addition to proximit detection, Automatic Open Relay Test Administration (AORTA) (124,132) is used to perform Open Relay (118) testing on all servers attempting to send a message.

### CROSS-REFERENCE TO RELATED APPLICATION

This application claims priority from U.S. Provisional Application 60/591,349 filed on Jul. 27, 2004, the contents of which are herein wholly incorporated by reference.

### BACKGROUND OF THE INVENTION

1. Field of Invention

The present invention relates to method for blocking unwanted electronic mail or SPAM at a recipient's mail receive server. More specifically, the present invention relates to a method for blocking SPAM that is based on sender identity, and conversely not on the content of the received electronic mail.

2. Discussion of Prior Art

E-mail has existed for over forty years. However, it was not until the opening of the Internet to the public twenty years ago, and the Internet's offering of a standardized and unified e-mail addressing system, that e-mail became a useful and almost universal communications tool. Unfortunately, the very things that make Internet e-mail useful and attractive—ease of use, universal access/penetration, and low cost—has also made it an extremely useful marketing tool for legitimate and, most importantly, illegitimate individuals and organizations. It has also become a useful tool for mischievous and malicious individuals who wish to pull pranks or cause serious damage.

Spam is a problem that has reached epidemic proportions. An independent research study by Nucleus Research in 2003 found that SPAM costs U.S. companies $874 per employee per year in lost productivity.

An article published in Network Computing magazine recently reported the following:

“In March of 2004, 63 percent of all Internet mail was spam, according to antispam technology vendor Brightmail, which says it filtered a whopping 2.93 billion spam messages that month alone. Postini, a corporate antispam service provider, reports that during one 24-hour period last month, nearly 109 million of the messages it processed—that's 83.6 percent—were spain. Lest you think the numbers are inflated because these companies have a vested interest in the subject, stats from NETWORK COMPUTING's own production mail server back them up: 78 percent of the messages our editors received in March were spatn. Admittedly, we're a prime target for spammers because our e-mail addresses are plastered all over our Web site, but the numbers are clearly worse than even the most dire predictions.

Which brings us to the obvious question: If everyone hates spain so much, why is it one of the largest growth industries in the world? Answer: Because people do make money by inundating us with advertisements for junk. As long as one sucker per 100,000 recipients responds to the “click here” or “call this number” portion of the spammer's message, there is sufficient incentive for sending out an additional 5 million messages.

It continues to amaze us that anyone could be dumb enough to respond to this stuff. Because anti-spam vendors have become adept at blocking simple spam, spammers have adopted tactics so bizarre that getting even one response in 1 million seems unlikely. E-mail message subjects regularly contain words that aren't words, gross misspellings, symbols that you'd normally find only in math equations, poor grammar and a host of other miscommunications that would typically render any message that followed completely suspect. Recent examples from our inbox include such memorable subject lines as “Re: legate enol,” “skul per vial hgra” and our personal favorite, “Give me some money, please.” But still, numbskulls click and call and encourage and keep the spam industry alive.

The fight against spam is being waged on two fronts, legal and technological. We hear from time to time about small claims and spectacular victories in the courtroom, but we believe—as do a majority of our antispam poll respondents—that legislative efforts alone will not eliminate spam. Only 11 percent of our 455 qualified respondents think legislative efforts are even somewhat effective deterrents to spam, and fewer than one in four holds out hope for more effective legislation in the future.

Legal challenges against spammers are complicated by three obstacles: tracking down the source of spam, identifying who the spammers really are, and dealing with international boundaries when attempting to prosecute identified spammers. Many IT people mistakenly think that most spam originates overseas and that U.S. legislative efforts would be effective against only a small portion of spam. But in February 2004, Sophos, an antivirus software provider, traced the origin of all spam received by its research center over a two-day period and found that nearly 60 percent was sent from within the United States. So the CAN-SPAM (Controlling the Assault of Non-Solicited Pornography and Marketing) Act of 2003 (see ID# 1501 buzz2) should be effective, right? Nope. Of the spam that's sent from within the States, between 30 percent (Sophos estimate) and 70 percent (according to MessageLabs, a British antispam service provider) is sent using computers that are infected with spam-relay Trojans and worms. These programs allow spammers from anywhere in the world to relay their messages through thousands of infected systems without the owners' knowledge.

Still, the Federal Trade Commission filed criminal and civil charges against four named defendants on April 29 for violating provisions in the CAN-SPAM Act. This marks the first government case against spammers based on the new law. If the government's case is successful, we're likely to see a number of additional government cases filed in the months to come, and that's good news. And in March, four U.S. firms—AOL, EarthLink, Microsoft and Yahoo—filed six lawsuits in four federal courts against hundreds of spammers using provisions in the CAN-SPAM Act. Emphasizing the difficulties inherent in identifying spammers, only three defendants were identified by name in the lawsuits, while more than 200 were tagged as John Doe.”

Most of the products in the marketplace today rely on “content filtering” to block spam messages. In fact, the excerpt cited above was the prelude to a test conducted by Network Computing of various anti-SPAM products, with the crucial criteria being content filtering effectiveness. Content filtering uses various rules to analyze the content of each incoming e-mail to determine whether or not the content of a message is considered objectionable, unwanted, or otherwise “spam-like”. Though this is an effective approach, it requires constant administration of lists that define the filter's rules, either from the service provider and/or local system administrator, so that the ongoing attempts by spammers to circumvent the filter's existing rules can be thwarted. Content filtering also requires that the entire message be accepted by the receiving server, even if the message will ultimately be rejected, wasting costly bandwidth.

The industry has recognized the limitations of content filtering and has determined that the most effective approach to spam filtering is “identity verification”. Upcoming products that have recently been announced all rely on various proprietary methods of allowing message identity to be verified. The problem with the known approaches is that they require the cooperation of the majority of non-spam e-mailers, as well as the application of new technologies, standards, software, and other technological “updates”, which are not ready yet. Many of these new technologies are not interoperable, and thus one vendor's method of certifying a message may not be recognized by another vendor's recognition technology. Additionally, privacy advocates are concerned with some of the proposals for establishing centralized authorities that will certify message authenticity.

What is needed to effectively wipe out SPAM is to provide a method that can effectively verify the sender of each message today.

Below is a list of the technical terms used in this document and their respective definitions.

DNS—Domain Name System/Domain Naming System—The primary system/service used on the Internet for translating Internet domain/host names into/from IP addresses

DNS Server—a server that provides the Domain Naming System service, typically translating Internet domain names into IP addresses

DNS Resource Record—a data record containing DNS information, supplied by a DNS server when replying to a DNS request

PTR (Pointer) Record—a DNS resource record that associates an IP address to an Internet domain name

MX (Mail Exchanger) Record—a DNS resource record that specifies a MX host for an Internet domain and its priority; a list of mail exchangers is then ordered by priority when delivering mail. MX records provide one level of indirection in mapping the domain part of an e-mail address to a list of host names which are meant to receive mail for that domain (dns.net)

A (Address) Record—a DNS resource record that identifies the 1P address(es) associated with an Internet host name

CNAME (Canonical Name) Record—a DNS resource record that identifies the Internet host name associated with a canonical (alias) host name

WWW Record—an “A” or “CNAME” DNS resource record that indicates a web server's address for an Internet domain name

MX Host—a mail exchanger (mail server) on the Internet that receives mail for a domain

SPAM—the common term for unsolicited e-mail. Some common types of spam include ads for pornographic sites, pyramid schemes, and advertisements for products that allow you to send spam. Other types of spam are messages that claim that you will win a prize or help a dying child by sending messages to all of your friends. (geek.com). Another form of spam is known as Unsolicited Commercial E-mail (UCE), which is commonly understood to be e-mail of a commercial nature that is received from a source that the receiver has no commercial relationship with.

Content Filtering—a method of determining if an e-mail is Spam, involving the application of various rules, keywords, etc. against the e-mail message contents

TTL (Time To Live)—the number of seconds left before a record expires

Reverse DNS Lookup—the process of resolving an IP address to a host name, using the PTR record; if no PTR record exists for a specified IP address, the lookup will fail

False positive—a legitimate e-mail message that is not delivered because a spam filter incorrectly identifies it as junk mail (source: baselinemag.com)

IP address—a unique number consisting of 4 parts separated by dots; every machine that is on the Internet has a unique IP address (source:matisse.net)

Ordinal number—a number that identifies the sequence of an item (source:techweb.com)

ISP—an institution that provides access to the Internet in some form (source:matisse.net)

Open Relay—an e-mail server that relays e-mail from any sender to any recipient

Spoof—forging the sending address of a third party in order to entice the recipient to read the message. E-mail spoofing is most often associated with spam, in which the name of a popular retailer is used to get the recipient's attention, who then opens and reads the fall message. (techweb.com)

BlackList—a list of habitual spammers used by a mail server to block spam

WhiteList—a list of trusted e-mail senders a mail server will always accept messages from

It should be noted that the above-mentioned definitions have been cited to help with a general understanding of networking, and are not meant to limit their interpretation or use thereof in the following specification. Other known definitions or equivalents may be substituted, without departing from the scope of the present invention. Also, whatever the precise merits, features, and advantages of prior art spam blocking techniques, none of them achieves or fulfills the purposes of the present invention.

### SUMMARY OF THE INVENTION

The present invention provides the needed solution via a proprietary set of algorithms that leverage Internet standards that are in place today to accurately trace and verify the source of any incoming e-mail. Most importantly, the present invention is completely self-contained, and does not require any changes to the way e-mail systems currently generate messages. The present invention also does not require e-mailers to cooperate on a newly defined e-mail verification system. The present invention does not require email servers to register with a new central authority and it does not require the message sender to do anything differently to certify a message and its source. The present invention can properly identify messages coming from any Internet-based message system today.

The present invention takes a unique approach to blocking SPAM by using unique algorithms that provide for “proximity detection”. Proximity detection provides a method of determining whether or not the sender of the message is authentic, by verifying if the sending host is within proximnity of registered MX Hosts, WWW Hosts, and/or DNS servers associated with the sending domain.

Existing Internet standards have long provided a method for verifying the source of e-mail messages. The specific standard relies on the defined Domain Name System, in general, and on “Pointer Resource Records” in specific. This process is otherwise known as a Reverse DNS Lookup. Unfortunately, a very large number of e-mail system administrators do not properly maintain their individual Pointer Resource Records, rendering this verification method useless on its own.

Proximity detection, combined with Reverse DNS lookups, provides an extremely effective and accurate e-mail source verification system. Additionally, this combination relies solely on the existing Internet Domain Name System for its identifying matrix. This is what allows the present invention to be an effective anti-SPAM system today, without making any changes to any installed e-mail systems.

In addition to proximity detection, the present invention also provides for Automatic Open Relay Testing Administration (AORTA) and Selective Reverse DNS. A significant amount of SPAM is sent via e-mail servers that are configured as open relays. These open relays allow for messages to be sent to recipients while spoofing the sender's identity. AORTA provides a mechanism for performing Open Relay testing on all servers attempting to send a message through the anti-span device. In addition to performing these tests, AORTA will manage a list of servers already tested and-the response given at the time. Each entry in the list will have a TTL associated with it, which will inform AORTA which servers need to be tested.

Reverse DNS lookups provide a method of verifying the identity of a sending e-mail server. However, as described above, this method of verification can produce false positives as many servers on the Internet do not have the appropriate records configured. Selective Reverse DNS (SRD) recognizes that a significant number of e-mail servers on the Internet do not have proper PTR records allowing for a reverse DNS lookup. To that end, SRD will perform reverse DNS lookups on specified domains that are required to pass a reverse DNS lookup. By default, SRD will have a list of the E-mail Service Providers and ISPs that must pass a reverse DNS lookup to send mail. In addition, customers will have the ability to add additional domains that they require to pass a reverse DNS lookup. This eliminates the need for ALL senders to pass criteria that many are not appropriately configured for.

Unlike other anti-spam systems, all spam that makes it past the present invention consists of messages that have one thing in common—they are coming from systems with registered domain names. As such, every one of these messages can be traced to a physical source. In other words, senders of spam that is able to bypass the present invention are unable to hide themselves behind the various anonymity facilities afforded by the Internet.

What at first glance appears as a strength—that is, an ability to send spam that bypasses the present invention's system—ultimately is a wealness, in that these spammers are forced to reveal themselves, and thus expose themselves to civil and criminal prosecution.

### BRIEF DESCRIPTION OF THE DRAWINGS

FIG. 1 illustrates an overview of the present invention's method.

FIG. 2 illustrates an example of how the IP address of sender is checked against various white lists.

FIG. 3 illustrates an example of how the IP address of sender is checked against various black lists.

FIG. 4 illustrates a flowchart depicting the method implemented in AORTA.

FIG. 5 illustrates a step-by-step flowchart of how local addresses are handled by the present invention.

FIG. 6 illustrates a flowchart of how a NSI scenario (when no SMTP sender exists) is handled by the present invention.

FIG. 7 illustrates a flowchart of how selective RDNS is handled by the present invention.

FIG. 8 illustrates the MX record look up procedure that is used in conjunction with the present invention.

FIG. 9 illustrates the WWW record look up procedure that is used in conjunction with the present invention.

FIG. 10 illustrates the NS record look up procedure that is used in conjunction with the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Proximity Detection

Proximity Detection is a method of determining the authenticity of the message sender by determining whether the sender's IP address falls into a range of networks they currently have a mail server, web server or DNS server residing on. This process rejects messages that claim to be from systems that have not, in fact, been the source of the message. The vast majority of spammers forge their “sender” names. This trick is otherwise known as address “spoofing”, and is used to hide the spammers' identities, as well as to trick victims into opening a message that looks like it is coming from a familiar source. Although Proximity Detection is similar in some ways to Reverse DNS lookups, it is much more effective in that it dramatically reduces false positives and false negatives, as it gives leniency to legitimate senders who may not have their PTR records set up properly. Reverse DNS, the method used by many identity-based anti-spam products, produces false results for those who do not have their PTR records set up properly, and misconfigured PTR records are extremely common on the Internet.

As noted above, Proximity Detection is similar, in some ways, to Reverse DNS lookups. Both methods use the IP address of the message sender (an identifying bit of information that is extremely difficult to counterfeit) as a basis for identifying the sender. Reverse DNS lookups use the PTR record associated with the IP address in a comparison to the message sender's claimed identity. If PTR record information is from the same domain as the message sender's claimed domain identity, the message is accepted. Unfortunately, as stated above, PTR record information is often non-existent for many mail systems. The present invention's design recognizes this limitation, and also recognizes that there is other information related to the message sender's IP address that is much more likely to exist, and to be accurate. That information includes the IP addresses of the senders' domain's mail-receiving hosts, web sites, and name servers. These IP addresses are critical to the proper operation of most Intemet-connected networks, and as such can be relied on as a highly consistent identification source.

These IP addresses are typically not identical to the IP address that would be associated with a legitimate mail-sending system for a given domain. However, it is extremely likely that these IP addresses will be near the IP address related to the legitimate message sender. This fact is what the present invention relies on for the design and function of its unique identity algorithms.

The proximity detection test that is used to verify authenticity of a sender depends on the category the sender falls into. Below is a table that lists the categories and the respective tests that category must pass to be accepted.

TABLE 1

| Category of Sender | Tests to Pass |
|---|---|
| E-mail provider hosting own | Selective Reverse DNS |
| mail | |
| E-mail provide not hosting own | MX lookup |
| mail | |
| ISPs | Selective Reverse DNS and MX lookup |
| No Sender Information | Process mail header to find sender |
| Customer Requires Selective | Selective Reverse DNS |
| Reverse DNS | |
| Everyone Else | Selective Reverse DNS, MX Lookup, |
| | WWW Lookup, OR NS Record Lookup |

Below is a detailed description of each of the proximity detection tests, with examples.

MX Lookup

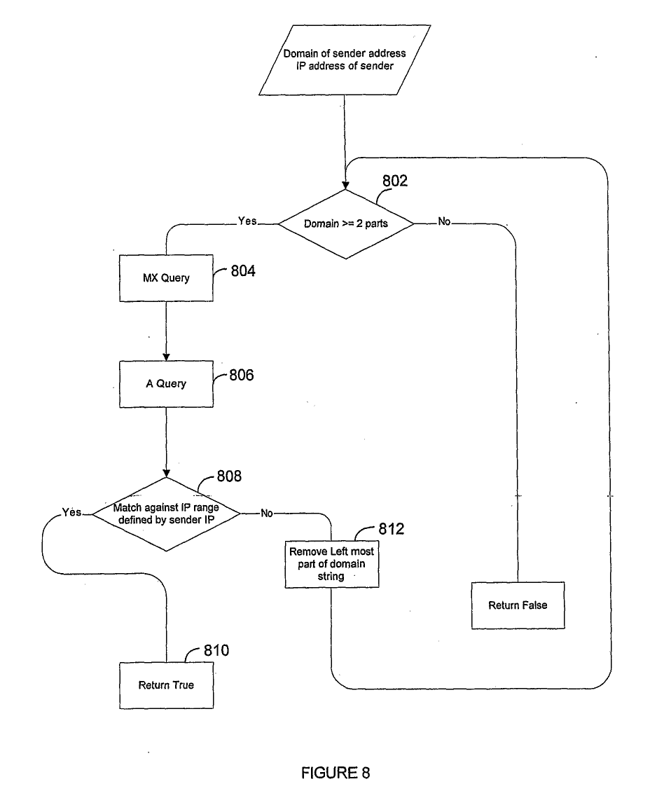

The MX Lookup determines whether the message sender's IP address is on or near the network that contains the sender's alleged domain's mail-receiving server (otherwise known as the MX server). This is done by converting the sender's IP address into an ordinal number, and then generating an IP address range of ordinal numbers that are “near” the sender's IP address. If any of the alleged domain's MX server's IP addresses is within the calculated range, the message sender's identity has been verified, and the message is accepted. FIG. 8 illustrates the MX Lookup procedure that is used in conjunction with the present invention. As illustrated in FIG. 8, the first decision is made by checking the validity of the domain name structure. If the domain name is made up of two or more “parts” (e.g. main.unassuming.com) 802, then the domain name is valid, and should be checked further. Next, in step 804, an “MX Query” against the domain is performed, i.e., find the list of servers designated to receive mail for the domain being tested. Next, in step 806, “A Queries” for each of the servers is performed in the retrieved MX list, whereby a list of IP addresses are acquired. Next, a decision 808 is made to compare each of these IP addresses against the IP address of the mail sender. If the sender's IP address is proximate to any of the IP addresses in the retrieved list, then, in step 810, the test passes. If this decision fails, then, in step 812, the leftmost part of the domain name being tested is removed (e.g., main.unassuming.com becomes unassuming.com), and the test is run again.

### EXAMPLE 1

ken@littlecompany.com sends a message to pzeller@ustelecom.com. When the message is intercepted by the present invention's device, it processes through the algorithm to the point where it must pass Selective Reverse DNS (SRD), MX Lookup, WWw Lookup, or NS Lookup. littlecompany.com has not set up their PTR record properly (a common mistake when businesses establish their presence on the Internet), so the SRD fails. The next test is the MX Lookup.

The MX Lookup will parse off everything following the @ symbol from the sender's e-mail address, in this case littlecompany.com. Then, an MX record lookup will be run against littlecompany.com to find the IP address(es) of the MX host(s). Once the IP address(es) is obtained, it is converted to an ordinal number. The routine then checks to see if the sending server is “near” the MX host(s) by comparing the server's (converted) address to the MX host's (converted) address(es). If the addresses are reasonably proximate, the test passes and the message is accepted. If not, it will fail this test and try the next test. Reasonable proximity is based on a value of within 10,752 IP addresses of the sender's IP address (5,376 IP addresses in either direction). Optionally, the proximity value can be set uniquely for individual domains that may require tighter or looser tolerances.

In this example, the message from ken@littlecompany.com is being sent from a server with the IP address 10.1.1.25. When the MX Lookup occurs, it fmds the MX record for littlecompany.com contains a host with the IP address 10.1.1.10. 10.1.1.10 is within 10,752 IP addresses of 10.1.1.25, thus the message has been identified as coming from its alleged source, and is accepted.

### EXAMPLE 2

A spammer is sitting at home at his computer, which is connected to a Verizon DSL circuit. The spammer sends a message from buyme@verizon.net to pzeller@ustelecom.com. When the message is intercepted by the present invention, it processes through the algorithm to the point where it is determined that it must pass both SRD and MX Lookup, since verizon.net is a known ISP, and all known ISP's must pass both tests. verizon.net sets up PTR records properly for all of its DSL customers, so the SRD passes. The next test is the MX Lookup.

The MX Lookup will parse off everything following the @ symbol from the sender's e-mail address, in this case verizon.net. Then, an MX record lookup will be run against verizon.net to find the IP address of Verizon's MX host(s).

In this example, the message from buyme@verizon.net is being sent from a machine with the IP address 192.168.1.250. When the MX Lookup occurs, it finds the Mx host for verizon.net is 10.1.1.203. 192.168.1.250 is NOT within 10,752 IP addresses of 10.1.1.203, therefore the message fails this test and is rejected as SPAM.

This is a common configuration for an ISP and a very common spammer scenario. ISPs typically set up the PTR records properly for DSL/Cable modem circuits. ISPs also typically keep their broadband customers IP addresses distant from their various mail, web and DNS servers. Spammers will often send a message with a spoofed sender name, however using their ISPs domain name. Spammers do this so when an anti-SPAM filter runs a reverse DNS test against the sender's IP address, it will be accepted. If a recipient's anti-SPAM filter's only criteria is Reverse DNS, the message will be accepted.

This example (as well as the following example) highlights the fact that the present invention's proximity detection algorithm is not simply an alternate “flavor” of the Reverse DNS Lookup, but can, in these types of cases, when used in conjunction with a Reverse DNS Lookup, improve on the false negative ratio that Reverse DNS Lookups generate.

### EXAMPLE 3

fund.raiser@small-non-profit.org sends a message to pzeller@ustelecom.com. When the message is intercepted by the present invention, it processes through the algorithm to the point where it must pass SRD, MX Lookup, WWW Lookup, or NS Lookup. small-non-profit.org has a third party (3rdparty.com) hosting their e-mail servers. 3rdparty.com has a PTR record setup for this IP address, however the name SRD returns is 3rdparty.com, not small-non-profit.org, therefore the SRD fails. The next test is the MX Lookup.

The MX Lookup will parse off everything following the @ symbol from the sender's e-mail address, in this case small-non-profit.org. Then, an MX record lookup will be run against small-non-profit.org to find the IP address of the MX host(s).

In this example, the message from fund.raiser@small-non-profit.org is being sent from a server with the IP address 172.16.1.64. When the MX Lookup occurs, it finds the MX record to say that the MX host for small-non-profit.org is 172.16.1.64. 172.16.1.64 is within 10,752 IP addresses (in this case, the same IP address), therefore the message is accepted.

WWW Lookup

The WWW Lookup determines whether the message sender's IP address is on or near the network that contains the sender's alleged domain's web server. This is done by converting the sender's IP address into an ordinal number, and then generating an IP address range of ordinal numbers that are “near” the sender's IP address. If any of the alleged domain's web server's IP addresses is within the calculated range, the message sender's identity has been verified, and the message is accepted.

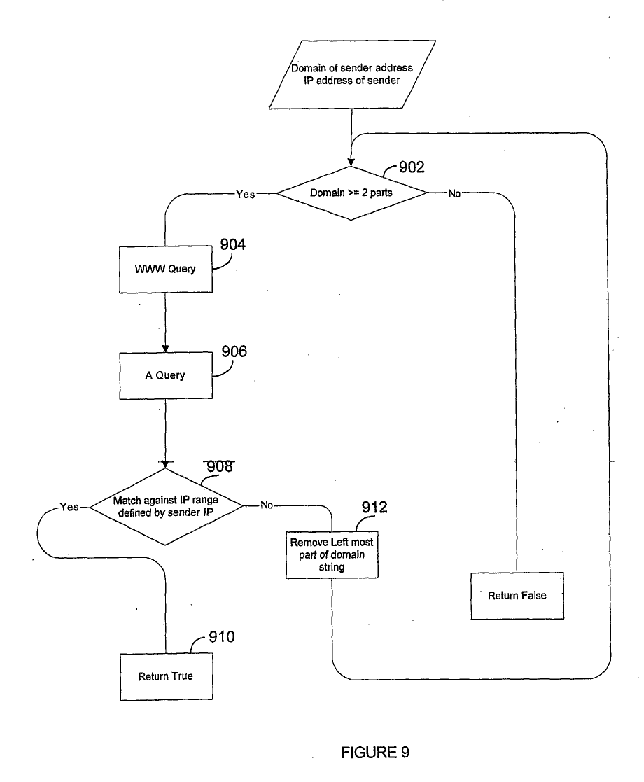

FIG. 9 illustrates the WWW Lookup procedure that is used in conjunction with the present invention. As illustrated in FIG. 9, the first decision 902 is made by checking the validity of the domain name structure. If the domain name is made up of two or more “parts” (e.g. main.unassuming.com), then the domain name is valid, and should be checked further in step 904. Next, “www.” is prepended to the domain name structure under test. Next, in step 906, an “A Query” is performed for a possible server with the newly created name (e.g. www.main.unassuming.com), whereby a list of IP addresses is acquired. The next decision—step 908—is to now compare each of these IP addresses against the IP address of the mail sender. If the sender's IP address is proximate to any of the IP addresses in the retrieved list, then, in step 910, the test passes. If this decision fails, in step 912, then the leftmost part of the domain name being tested is removed (e.g. main.unassuming.com becomes unassuming.com), and the test is run again.

### EXAMPLE

tom@biggercompany.com sends a message to pzeller@ustelecom.com. When the message is intercepted by the present invention, it processes through the algorithm to the point where it must pass SRD, MX Lookup, WWW Lookup, or NS Lookup.biggercompany.com has not set up their PTR record properly causing the SRD to fail. biggercompany.com has a third party host their incoming mail, while biggercompany.com processes their own outgoing mail. This configuration will cause the MX lookup to fail as the sending server is not within the proximity of their MX host noted on the Internet.

The WWW Lookup will parse off everything following the @ symbol from the sender's e-mail address, in this case biggercompany.com. Then, an Address record lookup will be run against www.biggercompany.com to find the IP address(es) of the web server(s) for the biggercompany.com domain. Once the IP address(es) is obtained, it is converted to an ordinal number. The routine then checks to see if the sending server is “near” the web server(s) by comparing the server's (converted) address to the web host's converted address(es). If the addresses are reasonably proximate, the test passes and the message is accepted. If not, it will fail this test and try the next test. Reasonable proximity is based on a default value of within 10,752 IP addresses of the sender's IP address (5,376 IP addresses in either direction). Optionally, the proximity value can be set uniquely for individual domains that may require tighter or looser tolerances.

In this example, the message from ken@biggercompany.com is being sent from a server with the IP address 10.1.2.25. When the WWW Lookup occurs, the web server's Address record reports that the IP address for biggercompanycom's web server is 10.1.2.80. 10.1.2.80 is within 10,752 IP addresses of 10.1.2.25, thus the message has been identified as coming from its alleged source, and is accepted.

This example illustrates a typical environment, where the sender's PTR record is not accurate, the sender has a third party receive mail for them while they send their own, but they have a web server within the proximity of their sending e-mail server.

NS Lookup

The NS Lookup determines whether the message sender's IP address is on or near the network that contains the sender's alleged domain's DNS server. This is done by converting the sender's IP address into an ordinal number, and then generating an IP address range of ordinal numbers that are “near” the sender's IP address. If any of the alleged domain's DNS server's IP addresses is within the calculated range, the message sender's identity has been verified, and the message is accepted.

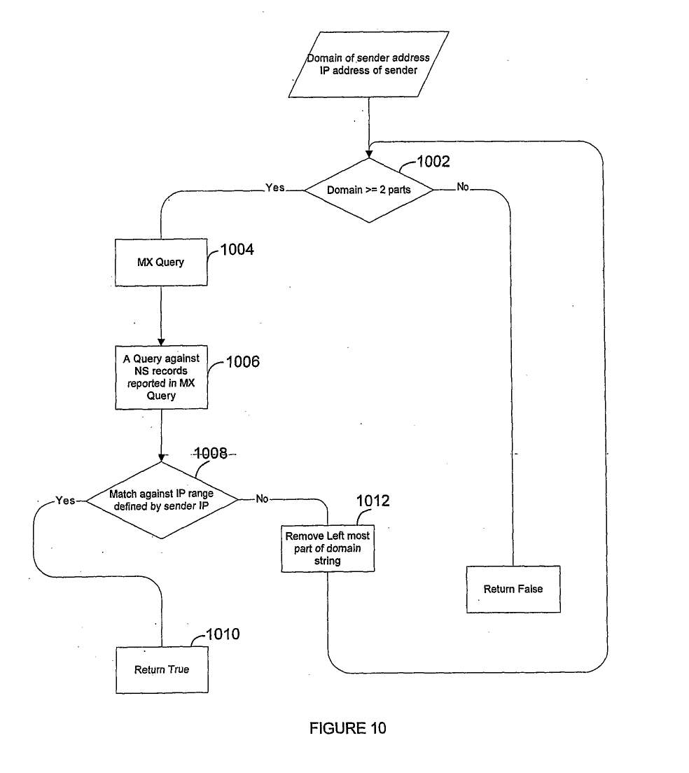

FIG. 10 illustrates the NS Lookup procedure that is used in conjunction with the present invention. As illustrated in FIG. 10, in step 1002, the first decision is made by checking the validity of the domain name structure. If the domain name is made up of two or more “parts” (e.g. main.unassuming.com), then the domain name is valid, and should be checked further. Next, in step 1004, an “MX Query” is performed against the domain name under test. This query will provide a list of NS (name server) records. Next, in step 1006, “A Queries” are performed against the list of name servers, whereby a list of IP addresses is acquired. The next decision—step 1008—is to compare each of these IP addresses against the IP address of the mail sender. If the sender's IP address is proximate to any of the IP addresses in the retrieved list, then, in step 1010, the test passes. If this decision fails, then, in step 1012, the leftmost part of the domain name being tested is removed (e.g. main.unassuming.com becomes unassuming.com), and the test is run again.

### EXAMPLE

john@privatecompany.com sends a message to pzeller@ustelecom.com. When the message is intercepted by the present invention, it processes through the algorithm to the point where it must pass SRD, Ma Lookup, WWW Lookup, or NS Lookup.privatecompany.com has not set up their PTR record properly causing the SRD to fail.privatecompany.com has a third party host their incoming mail, while privatecompany.com hosts their own outgoing mail. This configuration will cause the MX lookup to fail as the sending server is not within the proximity of their MX host noted on the Internet.privatecompany.com has the same third party hosting their web site, which would cause the WWW lookup to fail for the same reason.

The NS Lookup will parse off everything following the @ symbol from the sender's e-mail address, in this case privatecompany.com. Then, a NS record lookup will be run against privatecompany.com to find the IP address(es) of the DNS server(s). Once the IP address(es) is obtained, it is converted to an ordinal number. The routine then checks to see if the sending server is “near” the DNS server(s) by comparing the server's (converted) address to the DNS server's (converted) address(es). If the addresses are reasonably proximate, the test passes and the message is accepted. If not, it will fail this test and try the next test. Reasonable proximity is based on a default value of within 10,752 IP addresses of the sender's IP address (5,376 IP addresses in either direction). Optionally, the proximity value can be set uniquely for individual domains that may require tighter or looser tolerances.

In this example, the message from ken@privatecompany.com is being sent from a server with the IP address 10.1.3.25. When the NS Lookup occurs, the NS record reports that the IP address for one of privatecompanycom's DNS servers is 10.1.3.53. 10.1.3.53 is within 10,752 IP addresses of 10.1.3.25, thus the message has been identified as coming from its alleged source, and is accepted.

This illustrates a typical environment, where the sender's PTR record is not accurate, the sender has a third party receive mail and host web services for them, but they have a local DNS server within the proximity of their local sending e-mail server.

Automatic Open Relay Testing and Administration (AORTA)

A significant amount of SPAM is sent via e-mail servers that are configured as open relays. These open relays allow for messages to be sent to recipients while spoofing the sender's identity.

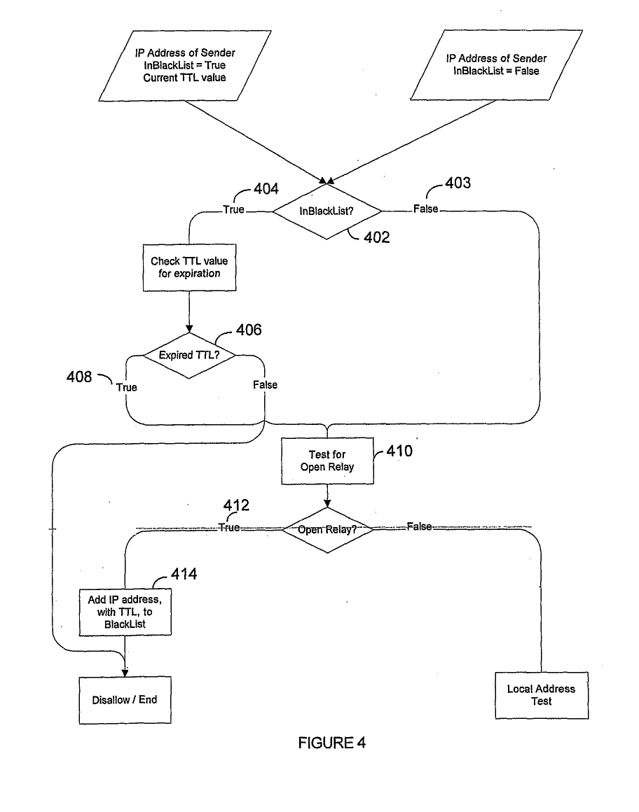

FIG. 4 illustrates a flowchart depicting the method implemented in AORTA. AORTA provides a mechanism for performing Open Relay testing on all servers attempting to send a message through the anti-spam device. To minimize network traffic, the anti-spatn devices will associate a Time-To-Live (TTL) for each server tested so that the sending servers are only tested periodically. While the TTL for the server is current, the server will not be tested. However, if the TTL has expired the server will be retested. To reduce the need for each anti-spam device to test servers that have already been tested by other anti-spain devices we have deployed, AIR (discussed later) will be used to distribute current lists. The lists will include TTL information, enabling the devices to only test after expiration.

AORTA checks to see if the IP address of a sender is in a maintained blacklist (such as previously open relay tested sites)—402, and if so—404, AORTA checks the TTL value for expiration 406. If the TTL value is expired—408, test for open relay 410 is performed again. If check 402 is negative (i.e., the IP address is not in blacklist) 403, AORTA proceeds to test for open relay 410. If an open relay is found 412, the blacklist is updated with the sender's IP address 414.

### EXAMPLE 1

A spammer finds an open relay server on the misconfigured.com domain. The spammer uses the open relay server on misconfigured.com to send a batch of spatn to the unassuming.com domain, disguising his identity by saying the sender of the message is abc123@hiddenidentity.com.

As in this' example, spammer's often spoof the sender's address to a domain that does not exist. These SPAM messages can only be traced back to the open relay server on misconfigured.com. However, the open relay was only the vehicle of the message, not the initiator. This is a favorite method of spammers as their identity is easily hidden, preventing the message from being traced back to them.

If unassuming.com had the present invention's system, AORTA would block this type of message. AORTA would check to see if the sending server is an open relay. If it found the server to be an open relay, the server would be noted in BlackList as an open relay, with a TTL noting the next time the server should be checked, and reject the message. If the server had already been checked, found to be an open relay, and the TTL was still valid, the message would be rejected without performing another open relay test.

### EXAMPLE 2

A spammer finds an open relay server on the unaware.com domain. The spammer uses the open relay server on unaware.com to send a batch of spam to the spamvictim.com'domain, disguising his identity by saying the sender of the message is freestuff@unaware.com.

In this example the spammer is spoofing the sender's address, using the domain name the open relay is sitting on. These SPAM messages can only be traced back to the open relay server on unaware.com. This is a common method for spammers as their identity is easily hidden, and the likelihood of the message being accepted is greater since a filter relying on reverse DNS will accept the message. AORTA would block this type of message.

To prevent ISP and E-mail Service Providers from having constant open relay tests performed against their servers, we will provide them the opportunity to register their e-mail servers with our Universal White List. Any entries in the Universal White List will be allowed to send messages without having to pass furrther tests, including AORTA. However, it is important to note that even those systems that do not register with our Universal White List will not be subject to constant Open Relay tests, as the TTL would regularly be increased as long as the ISP's server maintain themselves as non-open relays.

Selective Reverse DNS (SRD)

Reverse DNS Lookups are an extremely reliable means of identifying the actual sender of a message, but only in cases where the sending system has a properly configured PTR record. Recognizing, however, that a significant number of e-mail servers on the Internet do not have proper PTR records set up, this software will allow for a Selective Reverse DNS. SRD is a unique feature since all e-mail systems to date provide only a full Reverse DNS Lookup. In other words, if Reverse DNS Lookups are enabled on any of today's e-mail systems, then all messages are subjected to this test, and must pass the test in order to be accepted. There is no provision for testing only messages that claim to be from a list of specific domains. The SRD will perform reverse DNS lookups only on specified domains that are predetermined to have proper PTR records. At first glance, this may not seem like a significant improvement over existing anti-spain technology. However, it is important to note that a very popular spammer tactic is to spoof well known e-mail domains, such as hotmail.com, yahoo.com, etc. making their messages appear more legitimate to their victims. Since well known e-mail domains typically maintain proper PTR records, and since most well know e-mail domains have effectively blocked almost all spam that originates from their servers, SRD provides a foolproof and highly efficient method for blocking this type of spam. By default, SRD will have a list of the E-mail Service Providers and ISPs that must pass a reverse DNS lookup to send mail. In addition, the local administrator will have the ability to add additional domains that must pass a reverse DNS lookup.

### EXAMPLE 1

A spammer using a Road Runner cable modem attempts to send a message to pzeller@ustelecom.com, spoofing the sender's address as deals@yahoo.com. When the message is intercepted by the present invention, it processes through the algorithm to the point where it is determined that the yahoo.com domain must pass Selective Reverse DNS.

When SRD is run, the PTR record of the sending IP address returns a rr.com response, not a yahoo.com resp onse. At this point, SRD fails and the message is rejected.

### EXAMPLE 2

A customer (using the present invention's system) regularly gets e-mail from a client with a domain name of mediaconsultants.com. A spammer starts sending SPAM to this customer, spoofing the sender's name using the mediaconsultants.com domain. The spammer happens to be within the proximity of the legitimate mediaconsultants.corn domain, therefore the customer begins getting a mix of legitimate and SPAM messages from addresses with mediaconsultants.com domain name via the MX Lookup test.

The customer decides that they want to block this SPAM. They verify that mediaconsultants.com has a valid PTR record for their e-mail server. Once confirmed, they add mediaconsultants.com to the SRD list. After being added to the list, only the legitimate mail from mediaconsultants.com is received.

Though the likelihood of this situation happening is remote, SRD allows a customer to assure mail is received from a particular domain they know is configured properly, without having to add it to the WhiteList.

Active Information Renovation (AIR)

On a periodic basis, each of the anti-spam devices on the Internet that we have deployed and have current subscriptions, will initiate the AIR process. The device on the Internet will provide our master device its current Open Relays list, current software version, and a request for the latest software update. The master server will provide the device on the Internet the following updates: Open Relays Lists (compiled via all of the other devices deployed), Universal White Lists, Universal Black Lists, ISP list, E-mail Service Provider list, and Selective Reverse DNS list. In addition, the master server will update the requesting device's software if requested. The table below illustrates the AIR process:

TABLE 2

| Deployed Device provides Master | Master Server provides Deployed |
|---|---|
| Server | Device |
| Current Open Relay list | Updated Open Relay Lists |
| Current software version | Updated Universal White List |
| Request for latest software update | Updated Universal Black List |
| Administrator e-mail address | Updated ISP List |
| Expiration date of subscription | Updated E-mail Service Provider |
| service | List |
| | Updated Selective Reverse DNS List |
| | Updated software (if requested) |

The Master Server will compare the current software version of the deployed device with the latest version available. If the current version is not the latest and the device did not request a software update, the administrator of the deployed device will be sent a reminder e-mail message every X days that the software needs to be updated.

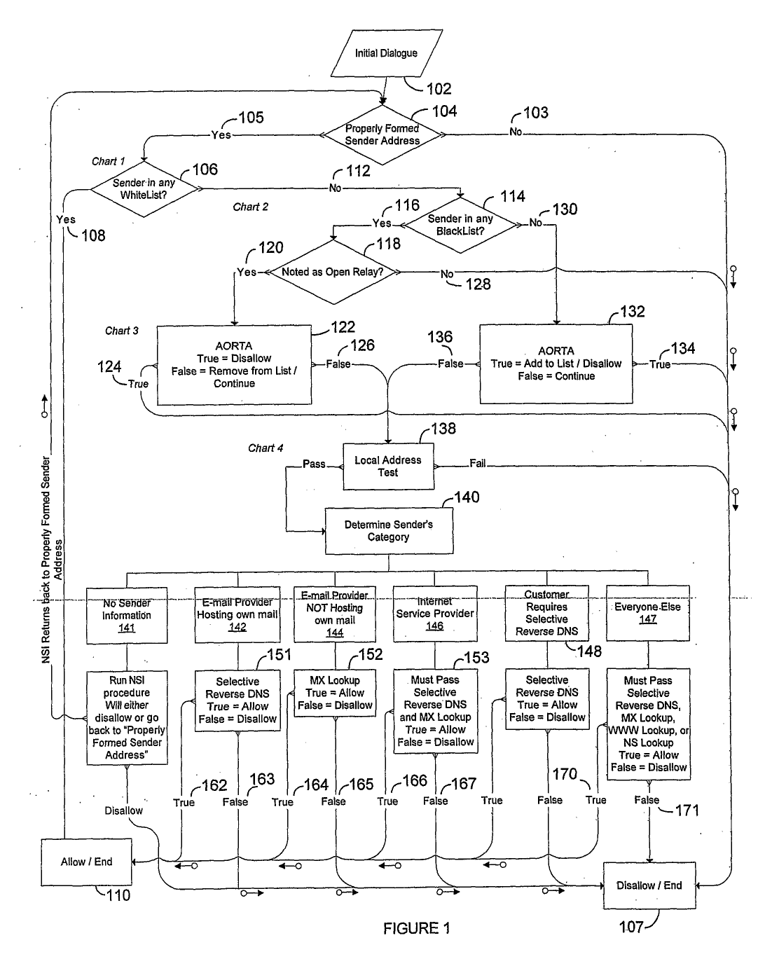

Algorithm Overview

| 1. | Initial Dialogue - 102 (as shown in FIG. 1) | | | | |
|---|---|---|---|---|---|
| | a. | Systems greet by hostname | | | |
| | b. | Retrieve sender IP address | | | |
| | c. | Retrieve sender e-mail address | | | |
| 2. | Check for properly formed sender address - 104 | | | | |
| | a. | Yes - 105 →3 | | | |
| | b. | No - 103 →Disallow→End - 107 | | | |
| 3. | White List - 106 | | | | |
| | a. | Yes - 108 →Allow→End - 110 | | | |
| | b. | No - 112 →4 | | | |
| 4. | Black List 114 | | | | |
| | a. | Yes - 116 | | | |
| | | i. | Noted as Open Relay - 118 | | |
| | | | 1. | Yes - 120 →5 (AORTA) - 122 | |
| | | | | a. | True 124 →Disallow→End - 107 |
| | | | | b. | False 126 →Remove from List→5.5 |

| | |
|---|---|
| 2. | No - 128 →Disallow→End 107 |

| b. | No - 130 →5 (AORTA) - 132 | |
|---|---|---|
| | i. | True - 134 →Disallow→End - 107 |
| | ii. | False - 136 →5.5 |

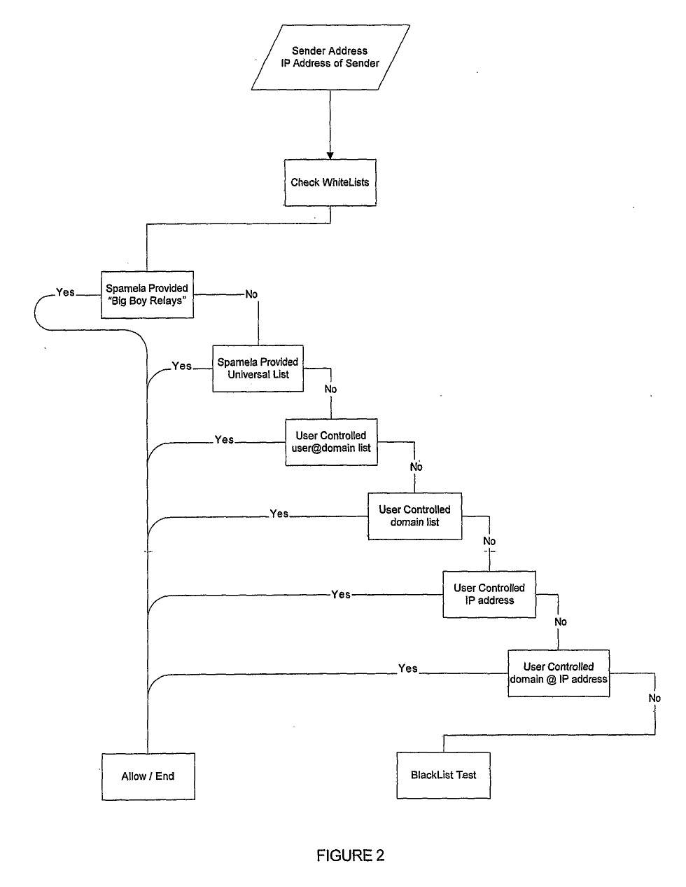

FIG. 2 illustrates how the IP address of a sender is checked against various white lists. The domain name of the sender is compared to the list of domains in the globally provided list of “Big Boy Relays”, and the sender's IP address is compared to the list of globally provided list of white-listed IP addresses. If a match is found in either of these lists, the message is allowed to pass. If a match is not found, similar comparisons are then made to end-user supplied domain and IP address lists, as well as specific user lists. If a match is found, the message is allowed to pass. If not, the message is passed to the next filter.

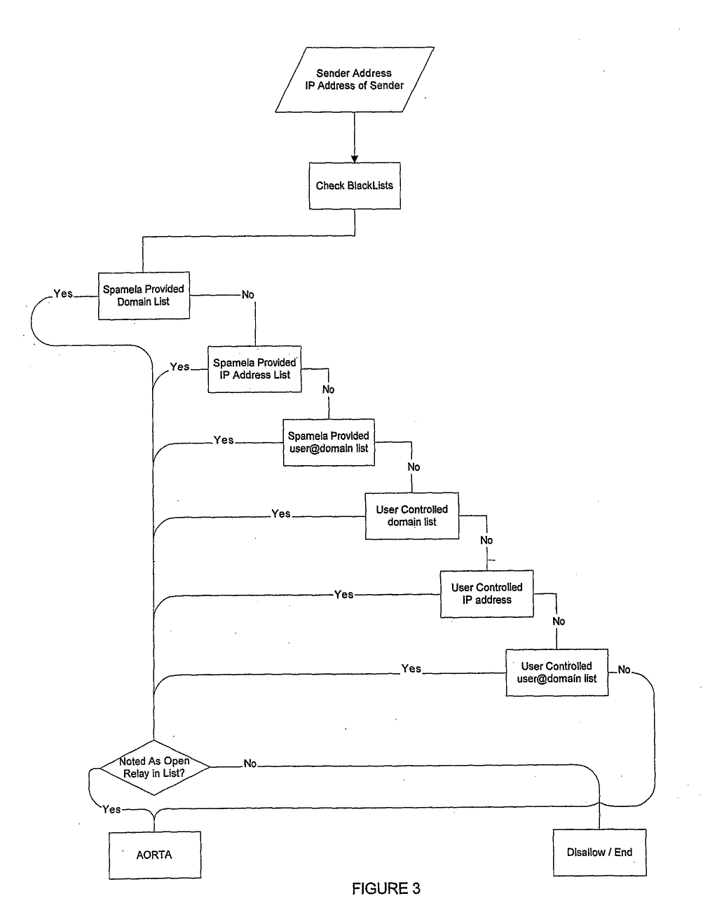

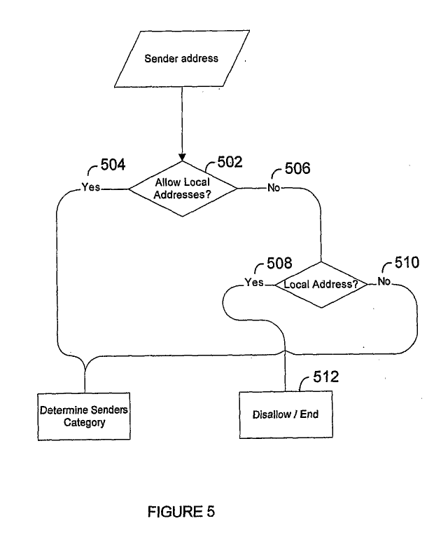

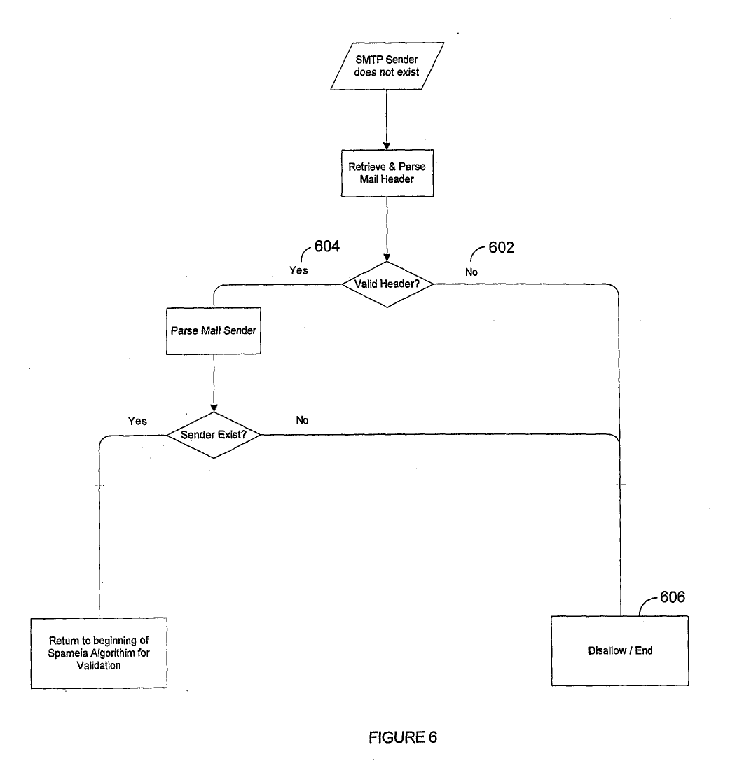

FIG. 3 illustrates how the IP address of a sender is checked against various black lists. The domain name of the sender is compared to the list of domains in the globally provided list of black-listed domains, and the sender's IP address is compared to the list of globally provided list of black-listed IP addresses. If a match is found in either of these lists, the sender is then checked against the list of Open Relays. If it is in the list, the message is passed to the AORTA filter. Otherwise the message is rejected. If a match is not found in either of the above lists, then similar comparisons are made to end-user supplied domain and IP address lists, as well as specific user lists. If a match is found in any of these lists, the sender is then checked against the list of Open Relays. If it is in the list, the message is passed to the AORTA filter. Otherwise the message is rejected.

| 5. | AORTA (True/False) - FIG. 4 illustrates a step-by-step | | | | | |
|---|---|---|---|---|---|---|
| | implementation of the AORTA algorithm. | | | | | |
| | a. | Check list to determine if system has been tested and | | | | |
| | | within TTL | | | | |
| | | i. | Yes - 122 →Return Status | | | |
| | | ii. | No - 132 →Test Open Relay | | | |
| | | | 1. | Yes→Add to/Update Black List- | | |
| | | | | 134 →Return True | | |
| | | | 2. | No→Add to Tested List - | | |
| | | | | 136→Return False | | |
| 5.5 | Local Address - 138 (flag is set to not allow local addresses | | | | | |
| | by default). FIG. 5 illustrates a step-by-step flowchart of | | | | | |
| | how local addresses are handled by the present invention. | | | | | |
| | a. | Allow Local Addresses? - 502 | | | | |
| | | i. | Yes - 504 →6 | | | |
| | | iii. | No - 506 →Check if sender's address is a | | | |
| | | | local address | | | |
| | | | 1. | Local Address - 508 →Disallow→End | | |
| | | | | - 512 | | |
| | | | 2. | Not Local Address - 510 →6 | | |
| 6. | Sender's Category - 140 | | | | | |
| | a. | E-mail provider hosting own mail - 142→7 | | | | |
| | b. | E-mail provider not hosting own mail - 144 →8 | | | | |
| | c. | ISPs - 146 →9 | | | | |
| | d. | Everyone else - 147 →10 | | | | |
| | e. | No sender information - 141 →11 | | | | |
| | f. | Customer requires Selective Reverse DNS - 148 →12 | | | | |
| 7. | E-mail provider hosting own mail - 142 | | | | | |
| | a. | 11 (Selective Reverse DNS) - 151 | | | | |
| | | i. | True - 162→Allow- 110→End | | | |
| | | ii. | False - 163→Disallow- 107→End | | | |
| 8. | E-mail provider not hosting own mail - 144 | | | | | |
| | a. | 12 (MX Lookup) - 152 | | | | |
| | | i. | True- 164→Allow- 110→End | | | |
| | | ii. | False- 165→Disallow- 107→End | | | |
| 9. | ISPs - 146 | | | | | |
| | a. | 13 (Selective Reverse DNS) - 153 | | | | |
| | | i. | True→12 (MX Lookup) | | | |
| | | | 1. | True- 166→Allow- 110→End | | |
| | | | 2. | False- 167→Disallow- 107→End | | |
| | | ii. | False- 167→Disallow - 107→End | | | |
| 10. | Everyone else - 147 | | | | | |
| | a. | 13 (Selective Reverse DNS) - 155 | | | | |
| | | i. | True- 170→Allow- 110→End | | | |
| | | ii. | False→12 (MX Lookup) | | | |
| | | | 1. | True- 170→Allow- 110→End | | |
| | | | 2. | False→15 (WWW Lookup) | | |
| | | | | a. | True- 170→Allow- | |
| | | | | | 110→End | |
| | | | | b. | False→16 (DNS | |
| | | | | | Lookup) | |
| | | | | | i. | True- |
| | | | | | | 170→Allow- 110→End |
| | | | | | ii. | False-171→Disallow- |
| | | | | | | 107→End |

| 11. | No Sender Information (NSI) (Begin receiving message to get | | | | |
|---|---|---|---|---|---|
| | header) - 141. FIG. 6 illustrates a flowchart of how a NSI | | | | |
| | scenario (when no SMTP sender exists) is handled by the | | | | |
| | present invention. | | | | |
| | a. | Message header valid? - 602 | | | |
| | | i. | Valid - 604 →Retrieve sender information | | |
| | | | from mail header | | |
| | | | 1. | Check if sender information is in | |
| | | | | mail header and valid | |
| | | | | a. | Yes→2 (Check for |
| | | | | | properly formed |
| | | | | | sender address) |
| | | | | b. | No→Disallow→End |

| | |
|---|---|
| ii. | Not Valid - 606 →Disallow→End |

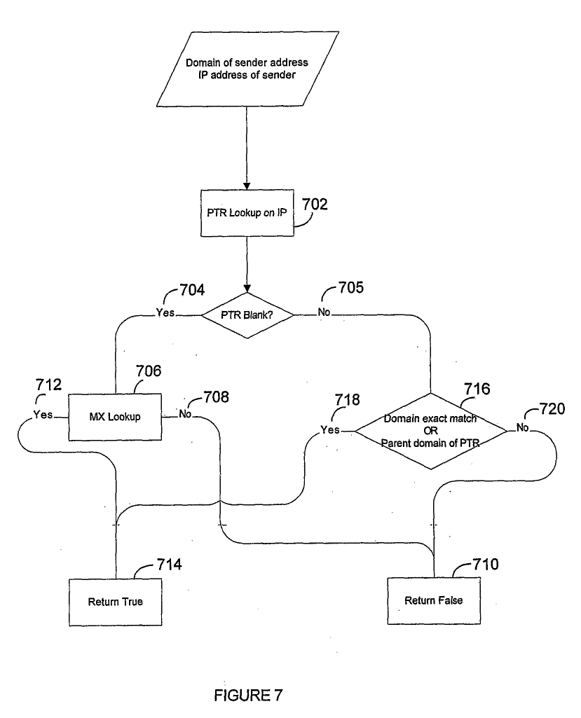

12. Customer requires Selective Reverse DNS—148. FIG. 7 illustrates a flowchart of how selective RDNS is handled by the present invention. A PTR lookup on the sender IP is first made 702 and, if the PTR is blank 704, a MX lookup is made 706. If MX lookup fails 708, the algorithm returns a false value 710; if MX lookup is successful 712, a true value 714 is returned by the algorithm. If PTR value is not blank 705, a check 716 is made to see if the domain is an exact match or if the domain is the parent domain of PTR. If the check is positive (i.e., an exact match or parent domain of PTR) 718, a true value 714 is returned by the algorithm, else 720 a false value 710 is returned.
   a. 11 (Selective Reverse DNS)
      i. True-168→Allow-110→End
      ii. False-169→Disallow-107→End
13. Selective Reverse DNS
14. MX Lookup
15. WWW Lookup
16. DNS Lookup

Additionally, the present invention provides for an article of manufacture comprising computer readable program code contained within implementing one or more modules to block unwanted e-mail. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) aiding in receiving an initial dialogue regarding an incoming electronic communication from a sending host to a recipient over a network; (b) verifying if said sending host's IP address is within at least one predefined proximity value of any one of, or a combination of, the following hosts associated with said sending host: an MX host, a WWW host, or a DNS server; and (c) blocking said incoming electronic communication if said verification is unsuccessful, else, receiving said incoming e-mail and forwarding said received e-mail to said recipient.

### Conclusion

A system and method has been shown in the above embodiments for the effective implementation of a method for blocking unwanted e-mail based on proximity detection. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of networking.

1. A method to block unwanted electronic communication based on proximity detection, said method comprising the steps of:
a. receiving an initial dialogue regarding an incoming electronic communication from a sending host to a recipient over a network;
b. verifying if said sending host's IP address is within at least one predefined proximity value of any one of, or a combination of, the following hosts associated with said sending host: an MX host, a VWW host, or a DNS server; and
c. blocking said incoming electronic communication if said verification is unsuccessful, else, receiving said incoming e-mail and forwarding said received e-mail to said recipient.

2. A method to block unwanted electronic communication based on proximity detection, as, per claim 1, wherein said electronic communication is an e-mail.

3. A method to block unwanted electronic communication based on proximity detection, as per claim 1, wherein said electronic communication is SPAM.

4. A method to block unwanted electronic communication based on proximity detection, as per claim 1, wherein said at least one proximity value is 10,752 and said verification step is successful if said sending host's IP address is within 10,752 IP addresses of any one of, or a combination of, said MX host, said WWW host, or said DNS server.

5. A method to block unwanted electronic communication based on proximity detection, as per claim 1, wherein proximity value is individually set for individual domains providing tighter and/or looser tolerances.

6. A method to block unwanted electronic communication based on proximity detection, as per claim 1, wherein said network is any of the following: local area network, wide are network, or the Internet.

7. A method to block unwanted e-mail based on proximity detection, said method comprising the steps of:
a. receiving an initial dialogue regarding an incoming e-mail from a mail server over a network, said incoming e-mail sent by a sending host intended for a recipient;
b. performing an open relay test on said mail server to identify if said mail server is an open relay server;
c. verifying if said sending host's IP address is within at least one predefined proximity value of any one of, or a combination of, the following hosts associated with said sending host: an MX host, a WWW host, or a DNS server; and
d. blocking said incoming e-mail if said verification in (c) is unsuccessful and/or said mail server is an open relay server, else, receiving said incoming e-mail and forwarding said received e-mail to said recipient.

8. A method to block unwanted e-mail based on proximity detection, as per claim 7, wherein said method further comprises the step of maintaining a blacklist of servers, each entry in said blacklist having previously failed said open relay test and having an associated time-to-live (TTL) value defining a time period after which said open relay test is to be repeated.

9. A method to block unwanted e-mail based on proximity detection, as per claim 7, wherein said unwanted e-mail is SPAM.

10. A method to block unwanted e-mail based on proximity detection, as per claim 7, wherein said at least one proximity value is 10,752 and said verification step is successful if said sending host's IP address is within 10,752 IP addresses of any one of, or a combination of, said MX host, said WWW host, or said DNS server.

11. A method to block unwanted e-mail based on proximity detection, as per claim 7, wherein said network is any of the following: local area network, wide are network, or the Internet.

12. A method to block unwanted e-mail based on proximity detection, said method comprising the steps of:
a. receiving an initial dialogue regarding an incoming e-mail from a sender intended for a recipient;
b. identifying a domain association with said sender's IP address by performing a selective reverse DNS (SRD) lookup on said sender's IP address, said SRD performed exclusively on domains that are predetermined to have proper PTR records;
c. verifying if said sending host's IP address is within at least one predefined proximity value of any one of, or a combination of, the following hosts associated with said sending host: an MX host, a WWW host, or a DNS server; and
d. blocking said incoming e-mail if said verification in (c) is unsuccessful and/or said identified domain in (b) fails to match domain associated with said sender's e-mail address, else, receiving said incoming e-mail and forwarding said received e-mail to said recipient.

13. A method to block unwanted e-mail based on proximity detection, as per claim 12, wherein said unwanted e-mail is SPAM.

14. A method to block unwanted e-mail based on proximity detection, as per claim 12, wherein said verification step is successful if said at least one proximity value is 10,752 and said sending host's IP address is within 10,752 IP addresses of any one of, or a combination of, said MX host, said WWW host, or said DNS server.

15. A method to block unwanted e-mail based on proximity detection, as per claim 12, wherein said network is any of the following: local area network, wide are network, or the Internet.

16. A plurality of anti-spam devices geographically distributed over at least one network, each of said devices blocking unwanted e-mail based on proximity detection algorithms, each device comprising:
a. a network interface to receive, over a network, an initial dialogue regarding an incoming e-mail from a sending host to a recipient;
b. a proximity detection module to extract sending host's IP address and verify if said sending host's IP address is within at least one predefined proximity value of any one of, or a combination of, the following hosts associated with said sending host: an MX host, a WWW, host, or a DNS server; and
c. said network interface blocking said incoming e-mail if said verification is unsuccessful, else, said network interface receiving said incoming e-mail and forwarding said received e-mail to said recipient.

17. A plurality of anti-spam devices geographically distributed over at least one network, each of said devices blocking unwanted e-mail based on proximity detection algorithms, as per claim 16, wherein each of said anti-sparn devices maintains, on a subscription basis, a plurality of the following lists: open relay list, universal white list, universal black list, ISP list, e-mail service provider list, or selective reverse DNS list, said lists used in conjunction with said proximity detection module to block unwanted e-mail.

18. A plurality of anti-spam devices geographically distributed over at least one network, each of said devices blocking unwanted e-mail based on proximity detection algorithms, as per claim 16, wherein said unwanted e-mail is SPAM.

19. A plurality of anti-spam devices geographically distributed over at least one network, each of said devices blocking unwanted e-mail based on proximity detection algorithms, as per claim 16, wherein said proximity detection module successfully verifies if said at least one proximity value is within 10,752 IP addresses of any one of, or a combination of, said MX host, said WWW host, or said DNS server.

20. A plurality of anti-spam devices geographically distributed over at least one network, each of said devices blocking unwanted e-mail based on proximity detection algorithms, as per claim 16, wherein said network is any of the following: local area network, wide are network, or the Internet.

21. An article of manufacture comprising a computer user medium having computer readable program code embodied therein which implements a method to block unwanted electronic communication based on proximity detection, said medium comprising:
a. computer readable program code aiding in receiving an initial dialogue regarding an incoming electronic communication from a sending host to a recipient;
b. computer readable program code verifying if said sending host's IP address is within proximity of any one of, or a combination of, the following hosts associated with said sending host: an MX host, a WWW host, or a DNS server; and
c. computer readable program code blocking said incoming electronic communication if said verification is unsuccessful, else, receiving said incoming e-mail and forwarding said received e-mail to said recipient.

22. A plurality of anti-spam devices geographically distributed over at least one network, each of said devices blocking unwanted e-mail based on proximity detection algorithms, each device comprising:
a. a network interface aiding in receiving an initial dialogue regarding an incoming e-mail from a mail server over a network, said incoming e-mail sent by a sending host intended for a recipient;
b. an open relay tester performing an open relay test on said mail server to identify if said mail server is an open relay server;
c. a proximity detection module verifying if said sending host's IP address is within 10,752 IP addresses of any one of, or a combination of, the following hosts associated with said sending host: an MX host, a WWW host, or a DNS server; and
d. a blocking module blocking said incoming e-mail if said verification in said proximity detection module is unsuccessful and/or said open relay tester verifies that said mail server is an open relay server, else, said network interface receiving said incoming e-mail and forwarding said received e-mail to said recipient.

23. A plurality of anti-sparn devices geographically distributed over at least one network, each of said devices blocking unwanted e-mail based on proximity detection algorithms, as per claim 22, wherein said network is any of the following: local area network, wide are network, or the Internet.

24. A plurality of anti-spam devices geographically distributed over at least one network, each of said devices blocking unwanted e-mail based on proximity detection algorithms, each device comprising:
a. a network interface aiding in receiving an initial dialogue regarding an incoming e-mail from a sender intended for a recipient;
b. an selective reverse DNS unit identifying a domain association with said sender's IP address by performing a selective reverse DNS (SRD) lookup on said sender's IP address, said SRD performed exclusively on domains that are predetermined to have proper PTR records;
c. a proximity detection module verifying if said sending host's IP address is within 10,752 IP addresses of any one of, or a combination of, the following hosts associated with said sending host: an Mx host, a WWW host, or a DNS server; and
d. a blocking module blocking said incoming e-mail if said proximity detection module unsuccessfully verifies and/or said domain identified by said SRD unit fails to match domain associated with said sender's e-mail address, else, said network interface receiving said incoming e-mail and forwarding said received e-mail to said recipient.

25. A plurality of anti-spam devices geographically distributed over at least one network, each of said devices blocking unwanted e-mail based on proximity detection algorithms, as per claim 24, wherein said network is any of the following: local area network, wide are network, or the Internet.
